(19) United States
(12) Patent Application Publication
(10) Pub. No.: US 2023/0243374 A1
(43) Pub. Date: Aug. 3, 2023

(54) DOUBLING-UP FITTING AND ASSOCIATED ASSEMBLY HAVING TWO DOUBLED-UP PLATES

(71) Applicant: Häfele Berlin GmbH & Co KG, Berlin (DE)

(72) Inventor: Gerd Sawatzki, Datteln (DE)

(73) Assignee: Häfele Berlin GmbH & Co KG, Berlin (DE)

(21) Appl. No.: 18/297,166

(22) Filed: Apr. 7, 2023

Related U.S. Application Data
(63) Continuation of application No. PCT/EP2021/076761, filed on Sep. 29, 2021.

(30) Foreign Application Priority Data
Oct. 19, 2020 (DE) 20 2020 105 956.4

(51) Int. Cl. F16B 5/02; F16B 12/14; F16B 12/24; F16B 13/06; F16B 37/14

(52) U.S. Cl. CPC F16B 5/0258; F16B 12/14; F16B 12/24; F16B 13/06; F16B 37/145; F16B 2012/103

(57) ABSTRACT

A doubling-up fitting includes an expansion sleeve which has a sleeve base with a sleeve base opening and has at least one expansion tab which can be spread radially outward. An inner ring is axially displaceable in the expansion sleeve towards the sleeve base in a tightening direction in order to spread the at least one expansion tab radially outward. A threaded bolt with a screw thread and with a bolt head engages behind the inner ring in the tightening direction. A threaded part has a widened head and can be screwed to the screw thread of the threaded bolt. The opening diameter of the sleeve base opening and the clear opening diameter of the inner ring are each greater than the bolt diameter of the threaded bolt.

### CROSS-REFERENCE TO RELATED APPLICATIONS

This continuation application claims priority to PCT/EP2021/076761 filed on Sep. 29, 2021 which has published as WO 2022/083989 A1 and also the German application number 20 2020 105 956.4 filed on Oct. 19, 2020, the entire contents of which are fully incorporated herein with these references.

### DESCRIPTION

### Field of the Invention

The invention relates to a doubling-up fitting for adjusting and fixing of two plates lying on one another (“doubled-up”), in particular furniture plates, e.g., drawer fronts, side panels or cover panels.

### Background of the Invention

Doubling-up fittings serve for example for fixing a front plate to the remaining body of the furniture, e.g., a flap fixing on the furniture body, and are usually screwed to the furniture body by means of threaded bolts. Here, an annular fitting housing, behind which the bolt head of the threaded bolt engages, is tapped into a blind bore of the front plate by an impact tool (e.g., hammer). A sleeved nut is placed in a passage bore in the furniture body and screwed to the threaded bolt. The greater clear opening diameter of the fitting housing compared with the bolt diameter allows a two-dimensional adjustment, of e.g., ±2 mm, of the contacting front plate relative to the furniture body. After adjustment, the sleeved nut is tightened until the front plate lies firmly on the furniture body. In this known doubling-up fitting, the fitting housing cannot be inserted manually into the blind bore but must be tapped with a tool in order to anchor the fitting housing firmly in the blind bore.

### SUMMARY OF THE INVENTION

In contrast, the invention is based on the object of providing a doubling-up fitting which can be installed easily and simply without an impact tool.

According to the invention, this object is achieved by a doubling-up fitting which comprises: an expansion sleeve which has a sleeve base with a sleeve base opening and has at least one expansion tab which can be spread radially outward; an inner ring which is axially displaceable in the expansion sleeve towards the sleeve base in a tightening direction in order to spread the at least one expansion tab radially outward; a threaded bolt with a screw thread and with a bolt head which engages behind the inner ring in the tightening direction; and a threaded part which has a widened head and can be screwed to the screw thread of the threaded bolt;

wherein the opening diameter of the sleeve base opening and the clear opening diameter of the inner ring are each greater than the bolt diameter of the threaded bolt. Preferably, the inner ring is axially displaceable in the expansion sleeve in the tightening direction as far as contact with the sleeve base, in order to spread the at least one expansion tab radially outward.

The doubling-up fitting according to the invention allows doubled-up plates lying on top of one another, such as e.g., drawer fronts, side panels or cover panels, to be adjusted in two dimensions and fixed in the respective adjusted position. The expansion sleeve can be inserted in a bore in a plate by hand, i.e., without tools, wherein during further mounting, the at least one expansion tab is spread open by the inner ring so as to thereby anchor the expansion sleeve in the bore.

Preferably, in the unspread state, the at least one expansion tab protrudes radially inward into the sleeve interior in order to cooperate with the inner ring. Also, in the unspread state, the at least one expansion tab may protrude radially outward beyond the sleeve wall, so that on insertion of the expansion sleeve into a bore with a snug fit, the at least one expansion sleeve is elastically deflected radially inward against the effect of a return force, whereby after insertion, the expansion sleeve is already fixed in the bore.

Particularly preferably, the inside of the at least one expansion tab and/or the outside of the inner ring run obliquely or conically radially inward, viewed in the tightening direction, in order to spread the at least one expansion tab radially outward by tightening of the inner ring.

The at least one expansion tab may be cut out of the sleeve wall. Advantageously, the axis about which the at least one expansion tab is deflected on spreading runs tangentially to the sleeve wall of the expansion sleeve.

In one embodiment of the doubling-up fitting according to the invention, the inner ring has a ring base with a ring base opening which forms the clear opening diameter of the inner ring. The bolt head engages behind the ring base in the tightening direction in order to carry the inner ring in the tightening direction.

Particularly preferably, the expansion sleeve comprises multiple expansion tabs which are arranged in particular rotationally symmetrically about the longitudinal axis of the expansion sleeve.

The threaded part may advantageously have a straight or cruciform actuating slot or an actuating contour, such as e.g., a polygonal socket or head, so that the threaded part can be turned by means of a tool.

Preferably, insofar as the threaded bolt has an external thread, the threaded part may be configured as a sleeve nut or shank nut, but insofar as the threaded bolt has an internal thread, it may alternatively also be configured as a shank bolt.

In a further aspect, the invention also relates to an assembly with two plates lying on one another, in particular furniture plates, and with a doubling-up fitting as described above, wherein the expansion sleeve, the inner ring and the threaded bolt with the bolt head ahead are inserted in a blind bore in the one first plate and the threaded part is inserted in a bore in the other second plate, and then screwed together, and wherein the at least one expansion tab is spread by the inner ring radially outward against the wall of the blind bore of the first plate.

Further advantages of the invention arise from the description, the claims and the drawing. Also, the above-mentioned features and those listed below may be used alone or together in any combination. The embodiments shown and described should not be regarded as a definitive list, but rather have an exemplary character for illustration of the invention.

### BRIEF DESCRIPTION OF THE DRAWINGS

In the drawings:

FIGS. 1a, 1b show the doubling-up fitting according to the invention in an exploded view (FIG. 1a) and in a longitudinal section (FIG. 1b) without an inner ring shown in FIG. 1a; and

FIG. 2 shows an assembly according to the invention with two doubled-up furniture plates adjusted by means of the doubling-up fitting.

### DETAILED DESCRIPTION OF THE PREFERRED EMBODIMENTS

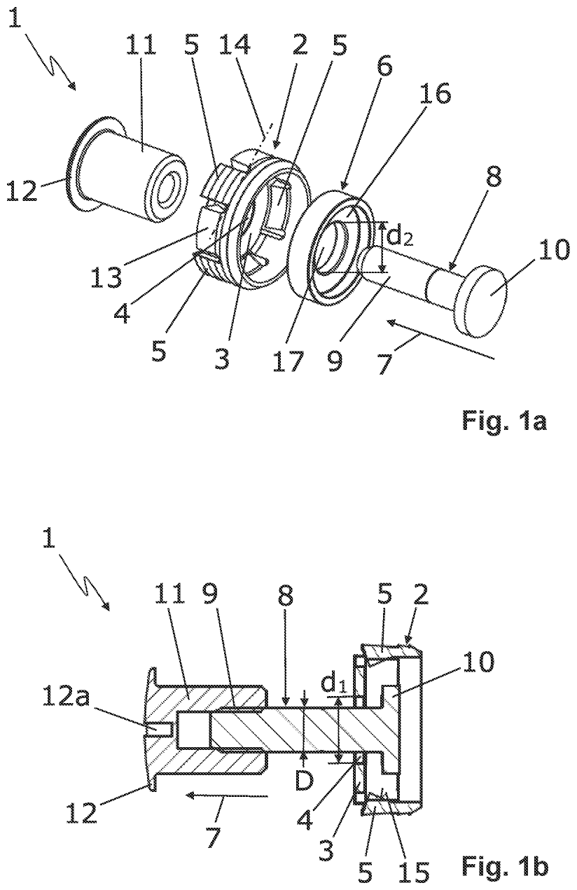

The doubling-up fitting 1 shown in FIGS. 1a, 1b serves for two-dimensional adjustment and fixing of two doubled-up furniture plates, e.g., drawer fronts, side panels or cover panels.

The doubling-up fitting 1 comprises the following individual components:
an expansion sleeve 2 of e.g., plastic (outer diameter e.g., 15 mm), which has a sleeve base 3 with a sleeve base opening 4 and multiple expansion tabs 5 which can be spread radially outward and are arranged rotationally symmetrically around the longitudinal axis of the expansion sleeve 2,
an inner ring 6 of e.g., plastic which is axially displaceable in the expansion sleeve 2 in a tightening direction 7 as far as contact with the sleeve base 4, in order to spread the expansion tab 5 radially outward,
a threaded bolt 8 with an external thread 9 and a bolt head 10 which engages behind the inner ring 6 in the tightening direction 7, and
a threaded part in the form of a shank nut or sleeve nut 11 (e.g., outer diameter 10 mm) which can be screwed onto the external thread 9 of the threaded bolt 8 and has a widened sleeve head 12 with an actuating slot 12a.

The expansion tabs 5 are cut out of the sleeve wall 13 of the expansion sleeve 2, wherein the axes 14 about which the expansion tabs 5 are deflected on spreading run tangentially to the sleeve wall 13. In the unspread state, the expansion tabs 5 protrude radially outward beyond the sleeve wall 13 and radially inward into the sleeve interior, wherein the insides 15 of the expansion tabs 5 run obliquely or conically radially inward viewed in the tightening direction 7. Alternatively or additionally, the outside of the inner ring 6 which cooperates with the insides 15 of the expansion tabs 5 may run obliquely or conically radially inward viewed in the tightening direction 7, so as to spread the expansion tabs 5 radially outward.

The inner ring 6 has a ring base 16 with a ring base opening 17 into which the threaded bolt 8 is inserted in order for its bolt head 10 to engage behind the ring base 16 in the tightening direction 7.

The opening diameter d1 of the sleeve base opening 4 and the opening diameter d2 of the ring base opening 17 are each larger than the bolt diameter D of the threaded bolt 8.

Instead of the actuating slot 13 shown, the sleeve nut 11 may also have a polygonal socket (e.g., internal hexagon) or a polygonal outer contour (e.g., polygonal head) so that the sleeve nut 11 can be turned by means of a tool. Instead of the external thread 9 shown, the threaded bolt 8 may also have a threaded bore with internal thread, in which a threaded part, formed as a shank bolt with widened bolt head, is screwed.

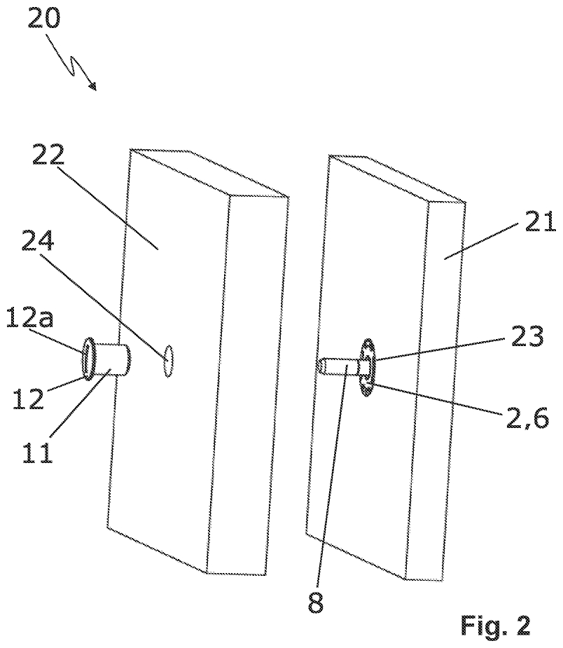

FIG. 2 shows an assembly 20 with two furniture plates 21, 22 lying on one another (“doubled-up”), which are adjusted and fixed by means of the doubling-up fitting 1. A blind bore 23 with a bore diameter (here 15 mm) corresponding to the outer diameter of expansion sleeve 2 is drilled in the outer furniture plate 21 (e.g., made of wood), and a (through) bore 24 with a bore diameter (here 10 mm) corresponding to the shank diameter of the sleeve nut 11 is drilled in the inner furniture plate 22. The expansion sleeve 2, the inner ring 6 and the threaded bolt 8 with bolt head 10 ahead are inserted in the blind bore 23. The expansion tabs 5 protruding radially outward beyond the sleeve wall 13 are elastically deflected radially inward against the effect of a return force, whereby after insertion, this assembly is already fixed in the blind bore 23. The sleeve nut 11 is pushed into the through bore 24 and screwed onto the threaded bolt 8 until the sleeve head 12 lies against the inner furniture plate 22.

The opening diameters d1, d2 of the sleeve base opening 4 and ring base opening 17 respectively, which are larger than the bolt diameter D, allow a two-dimensional adjustment of e.g., ±2 mm of the furniture plates 21, 22 lying on one another. During the final fixing by tightening of the sleeve nut 11, the inner ring 6 is brought to rest against the sleeve base 3, whereby the expansion tabs 5 are spread radially outward against the wall of the blind bore 23 and pressed into the wall of the blind bore 23. The adjusted, doubled-up furniture plates 21, 22 are now fixedly connected together.

Instead of being formed in four pieces as shown, the doubling-up fitting 1 may also be formed in three pieces if the expansion sleeve 2 and the inner ring 6 are initially produced as a common injection molding with one or more nominal break points, which are then broken during tightening of the sleeve nut 11.

What is claimed is:

1. A doubling-up fitting comprising:
an expansion sleeve which has a sleeve base with a sleeve base opening and has at least one expansion tab which can be spread radially outward;
an inner ring which is axially displaceable in the expansion sleeve towards the sleeve base in a tightening direction in order to spread the at least one expansion tab radially outward;
a threaded bolt with a screw thread and with a bolt head which engages behind the inner ring in the tightening direction; and
a threaded part which has a widened head and can be screwed to the screw thread of the threaded bolt;
wherein the opening diameter of the sleeve base opening and the clear opening diameter of the inner ring are each greater than the bolt diameter of the threaded bolt.

2. The doubling-up fitting as claimed in claim 1, wherein the inner ring is axially displaceable in the expansion sleeve in the tightening direction as far as contact with the sleeve base, configured to spread the at least one expansion tab radially outward.

3. The doubling-up fitting as claimed in claim 1, wherein in an unspread state, the at least one expansion tab protrudes radially inward into the sleeve interior.

4. The doubling-up fitting as claimed in claim 1, wherein in an unspread state, the at least one expansion tab protrudes radially outward beyond the sleeve wall.

5. The doubling-up fitting as claimed in claim 1, wherein the inside of the at least one expansion tab and/or the outside of the inner ring run obliquely or conically radially inward, viewed in the tightening direction.

6. The doubling-up fitting as claimed in claim 1, wherein the at least one expansion tab is cut out of the sleeve wall.

7. The doubling-up fitting as claimed in claim 1, wherein the axis about which the at least one expansion tab is deflected on spreading runs tangentially to the sleeve wall of the expansion sleeve.

8. The doubling-up fitting as claimed in claim 1, wherein the inner ring has a ring base, that the clear opening diameter of the inner ring is formed by a ring base opening in the ring base, and that the bolt head engages behind the ring base in the tightening direction.

9. The doubling-up fitting as claimed in claim 1, wherein the expansion sleeve comprises multiple expansion tabs which are arranged in rotationally symmetrically about the longitudinal axis of the expansion sleeve.

10. The doubling-up fitting as claimed in claim 1, wherein the threaded part has an actuating slot or an actuating contour.

11. The doubling-up fitting as claimed in claim 1, wherein the threaded part is configured as a sleeve nut or shank nut.

12. An assembly with two plates lying on one another and with the doubling-up fitting as claimed in claim 1, wherein the expansion sleeve, the inner ring and the threaded bolt with the bolt head first are inserted in a blind bore in the one first plate, and the threaded part is inserted in a bore in the other second plate, and then screwed together, and wherein the at least one expansion tab is spread by the inner ring radially outward against the wall of the blind bore of the first plate.

13. The assembly as claimed in claim 1, wherein the two plates are furniture plates.
